(19) United States
(12) Patent Application Publication
(10) Pub. No.: US 2016/0349163 A1
(43) Pub. Date: Dec. 1, 2016

(54) HELICAL VANE TOOL FOR RHEOLOGY MEASUREMENT AND METHOD OF USE THEREOF

(71) Applicant: Schlumberger Technology Corporation, Sugar Land, TX (US)

(72) Inventors: Yiyan Chen, Sugar Land, TX (US); Giselle Refunjol, Houston, TX (US); John Thomas Mayo, Houston, TX (US); Rod William Shampine, Houston, TX (US); Timothy Michael Lesko, Conway, AR (US)

(21) Appl. No.: 14/722,907

(22) Filed: May 27, 2015

(51) Int. Cl. G01N 11/14

(52) U.S. Cl. CPC G01N 11/14

(57) ABSTRACT

An apparatus and method are disclosed for measuring a rheology indicator in a rheometer utilizing a rheometer attachment including a shaft having a shaft axis, an outer surface, and a plurality of helical vanes each extending radially from the outer surface.

### FIELD

The disclosure generally relates to an apparatus and methods for measuring rheology, and more particularly, but not by way of limitation, apparatus and methods for measuring rheology using a helical vane rheology attachment.

### BACKGROUND

The statements in this section merely provide background information related to the disclosure and may not constitute prior art.

Viscous aqueous fluids are found and used in many industries, including the food, personal care product, chemical and petrochemical industries. As an example, in the oil and gas drilling and production industry, viscous aqueous fluids are commonly used in treating subterranean wells, as well as carrier fluids. Such fluids may be used as fracturing fluids, acidizing fluids, and high-density completion fluids. In an operation known as well fracturing, such fluids are used to initiate and propagate underground fractures for increasing petroleum productivity.

During fracturing operations, fluids pumped into the subterranean formation can include solids such as proppant or fibers mixed with a fluid such as an aqueous gel. Such fluids are mixed in a blender including a slinger and a pump impeller, each attached to a drive shaft and enclosed within a casing.

Rheology measurements are frequently required for such fluids in order to provide information for engineering design, quantitative fluid QAQC, product formulation developments, just to name a few. Many rheometers are designed to give data for these purposes. The ones that are most commonly used in the oilfield are of the concentric rotating rheometer type. However, as the fluids become more complex, the routine rheometer design will not be able to function well. For example, when fibers are added to a non-Newtonian fluid, due to the macroscopic nature of fibers in relation to the continuous gel or solution, and the induced macroscopic alignments/entanglements, rheology measurement can be very problematic. Another example is high solid content fracturing fluid, where particle sizes are too big for the gap in the rheometer. While the gap in the rheometer can be increased to some extent to marginally accommodate larger particle sizes, at some point the particle sizes are too big to be accommodated by larger gap size. To add more complexity to the picture, some shear induced gel structure can also cause the fluid to slip along the shearing walls leading to a measurement of only the solvent viscosities. Accordingly, there is a need for procedures and systems to measure rheology for fluids that are normally difficult to measure with existing rheometer geometries, such as high solid content fluids, highly slipping fluids, fluids with fibrous materials, and fluids with large particulates, such need met, at least in part, by the following disclosure.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

In an embodiment, a rheometer attachment includes a shaft having a shaft axis and an outer surface and a plurality of helical vanes each extending radially from the outer surface.

In accordance with another embodiment, the plurality of helical vanes each have an inner edge attached to the outer surface of the shaft.

In accordance with another embodiment, at least a portion of each of the plurality of helical vanes is at a variable helix angle, as measured from an axis parallel to the shaft axis, which increases at a rate of at least 1°/mm over the length of the inner edge from top to bottom.

In accordance with another embodiment, at least a portion of each of the plurality of helical vanes is at a fixed helix angle, as measured from an axis parallel to the shaft axis, of from about 5 to about 60 degrees.

In accordance with another embodiment, a rheometer comprises:
a container having an inner surface and a base defining a cavity; and
a rheometer attachment including a shaft having a shaft axis and an outer surface and a plurality of helical vanes each extending radially from the outer surface, wherein the rheometer attachment is disposed within the cavity.

In accordance with another embodiment, a method for measuring rheology includes:
utilizing a rheometer comprising:
   a container having an inner surface and a base defining a cavity;
   a cylindrical member selected from either a rotor or a stator disposed within the cavity;
   a rheometer attachment comprising a shaft having a shaft axis and an outer surface and a plurality of helical vanes each extending radially from the outer surface, wherein the rheometer attachment is disposed within the cylindrical member;
   a motor connected to either the cylindrical member or the shaft for causing the cylindrical member and the rheometer attachment to rotate relative to each other;
   a torque measuring device attached to either the cylindrical member or the shaft for measuring torque;
introducing a fluid to the cavity; and
operating the motor to cause either the cylindrical member or the shaft to rotate; and
measuring the torque using the torque measuring device and determining a
rheology indicator of the fluid as a function of the torque.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 illustrates some embodiments in accordance with the disclosure in perspective view.

FIG. 2 illustrates some embodiments in accordance with the disclosure in perspective view.

FIG. 3 illustrates some embodiments in accordance with the disclosure in perspective view.

FIG. 4 illustrates some embodiments in accordance with the disclosure in perspective view.

FIG. 5 illustrates some embodiments in accordance with the disclosure in perspective and cross section view.

FIG. 6 illustrates some embodiments in accordance with the disclosure in perspective and cross section view.

FIG. 7 is a plot of Rheometer Dial Reading vs. Time standing after pre-shear.

FIG. 8 is a plot of Rheometer Dial Reading vs. Time standing after pre-shear.

FIG. 9 is a plot of Rheometer Dial Reading vs. Time of pre-shear.

FIG. 10 is a plot of Viscosity vs. Time.

FIG. 11 shows configurations for Vanes 1-5.

FIG. 12 is a bar plot of Rheometer Dial Reading for Vanes 1-5 and BOB5 rheometer attachments.

FIG. 13 is a plot of Rheometer Dial Reading vs. Gelling Agent concentration.

FIG. 14 is a plot of Viscosity vs. Fiber concentration.

FIG. 15 is a bar plot of Rheometer Dial Reading for Fluids E, F and G.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Finally, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some aspects of the disclosure relate to apparatus for, and methods for, measuring rheology of fluids.

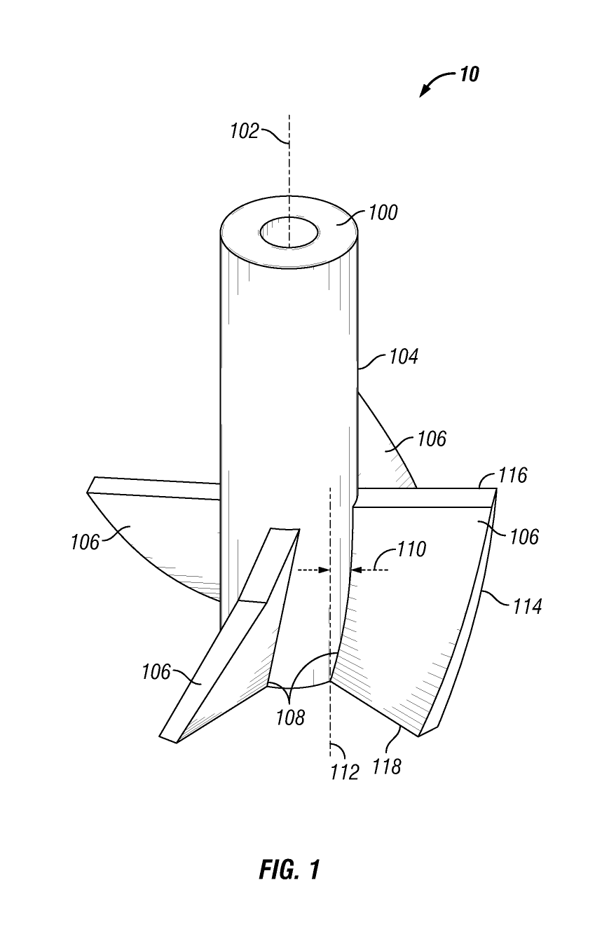

With reference to FIG. 1, in some embodiments, a rheometer attachment 10 can comprise, consist of, or consist essentially of a shaft 100 having a shaft axis 102 and an outer surface 104 and a plurality of helical vanes 106 each extending radially from the outer surface 104. The plurality of helical vanes 106 can each have an inner edge 108 attached to the outer surface 104 of the shaft 100. In some embodiments, at least a portion of each of the plurality of helical vanes 106 is at a fixed helix angle 110, as measured from an axis 112 parallel to the shaft axis 102, of from about 5 to about 60 or from about 10 to about 50 or from about 10 to about 40 or from about 10 to about 35 degrees. In some embodiments, the plurality of helical vanes 106 can extend substantially perpendicular from the outer surface 104. In some embodiments, each of the plurality of helical vanes 106 can have an outer edge 114, an upper side 116 extending between the inner edge 108 and the outer edge 114, and a lower side 118 extending between the inner edge 108 and the outer edge 114. In some embodiments, the ratio of the length of at least one of the upper side 116 and the lower side 118 to the length of the outer edge 114 is from about 0.3 to about 0.9 or from about 0.4 to about 0.8 or from about 0.5 to about 0.7. In some embodiments, the rheometer attachment can comprise up to six or up to five or up to four or up to three or up to two helical vanes 106. In some embodiments, the inner edge 108 is less than about 60% or less than about 50% or less than about 40% of the length of the shaft 100.

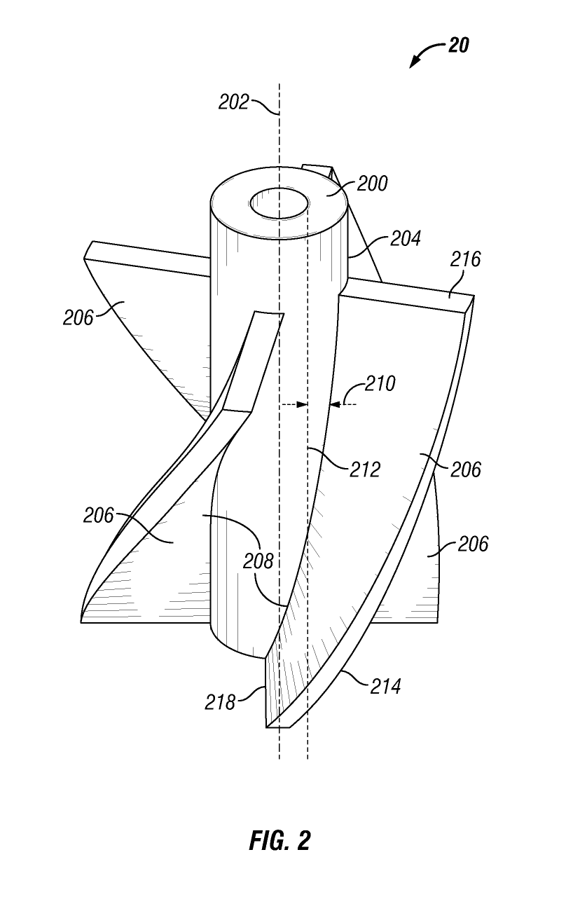

With reference to FIG. 2, in some embodiments, a rheometer attachment 20 can comprise, consist of, or consist essentially of a shaft 200 having a shaft axis 202 and an outer surface 204 and a plurality of helical vanes 206 each extending radially from the outer surface 204. The plurality of helical vanes 206 can each have an inner edge 208 attached to the outer surface 204 of the shaft 200. In some embodiments, at least a portion of each of the plurality of helical vanes 206 is at a fixed helix angle 210, as measured from an axis 212 parallel to the shaft axis 202, of from about 5 to about 60 or from about 10 to about 50 or from about 10 to about 40 or from about 10 to about 35 degrees. In some embodiments, the plurality of helical vanes 206 can extend substantially perpendicular from the outer surface 204. In some embodiments, each of the plurality of helical vanes 206 can have an outer edge 214, an upper side 216 extending between the inner edge 208 and the outer edge 214, and a lower side 218 extending between the inner edge 208 and the outer edge 214. In some embodiments, the ratio of the length of at least one of the upper side 216 and the lower side 218 to the length of the outer edge 214 is from about 0.3 to about 0.9 or from about 0.4 to about 0.8 or from about 0.5 to about 0.7. In some embodiments, the rheometer attachment can comprise up to six or up to five or up to four or up to three or up to two helical vanes 206. In some embodiments, the inner edge 208 is greater than about 65% or greater than about 75% or greater than about 80% of the length of the shaft 200.

In some embodiments, the plurality of helical vanes 106 and 206 shown in FIGS. 1 and 2, respectively, can be positioned anywhere along shaft 100 or 200 in addition to the positions shown in FIGS. 1 and 2.

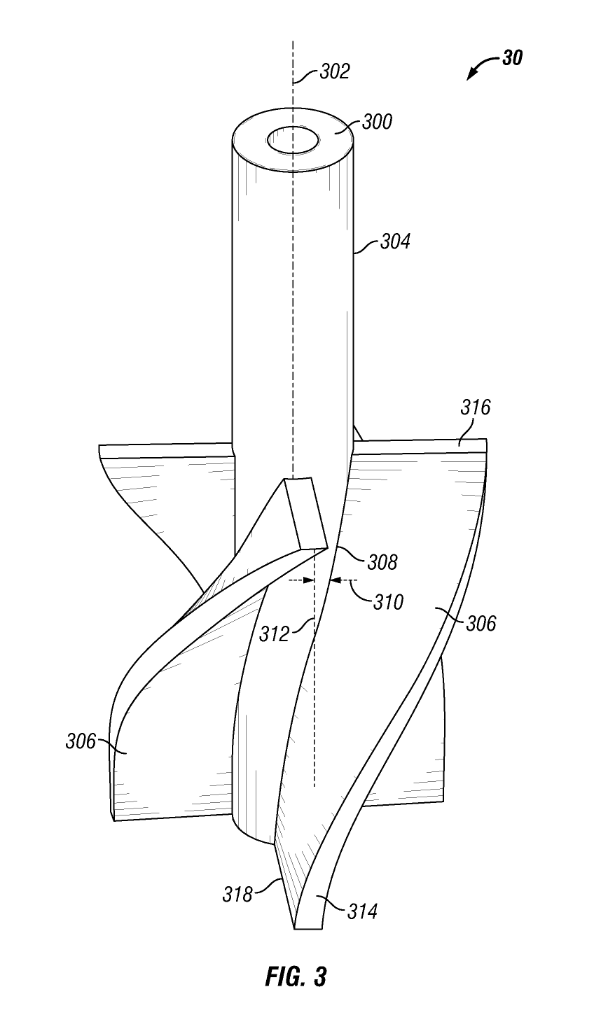

With reference to FIG. 3, in some embodiments, a rheometer attachment 30 can comprise, consist of, or consist essentially of a shaft 300 having a shaft axis 302 and an outer surface 304 and a plurality of helical vanes 306 each extending radially from the outer surface 304. The plurality of helical vanes can each have an inner edge 308 attached to the outer surface 304 of the shaft 300. In some embodiments, the plurality of helical vanes 306 can extend substantially perpendicular from the outer surface 304. In some embodiments, each of the plurality of helical vanes 306 can have an outer edge 314, an upper side 316 extending between the inner edge 308 and the outer edge 314, and a lower side 318 extending between the inner edge 308 and the outer edge 314. In some embodiments, the ratio of the length of at least one of the upper side 316 and the lower side 318 to the length of the outer edge 314 is from about 0.3 to about 0.9 or from about 0.4 to about 0.8 or from about 0.5 to about 0.7. In some embodiments, the rheometer attachment 30 can comprise up to six or up to five or up to four or up to three or up to two helical vanes 306. In some embodiments, at least a portion of each of the plurality of helical vanes 306 is at a variable helix angle 310, as measured from an axis 312 parallel to the shaft axis 302, which increases at a rate of at least about 1°/mm or at least about 2°/mm or at least about 3°/mm over the length of the inner edge 308 from upper side 316 to lower side 318. In some embodiments, the inner edge 308 is less than about 60% or less than about 50% or less than about 40% of the length of the shaft 300.

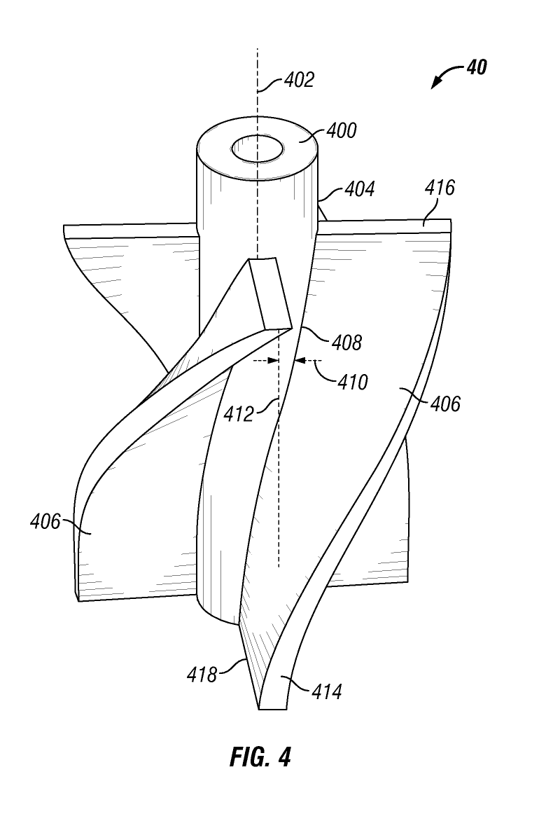

With reference to FIG. 4, in some embodiments, a rheometer attachment 40 can comprise, consist of, or consist essentially of a shaft 400 having a shaft axis 402 and an outer surface 404 and a plurality of helical vanes 406 each extending radially from the outer surface 404. The plurality of helical vanes can each have an inner edge 408 attached to the outer surface 404 of the shaft 400. In some embodiments, the plurality of helical vanes 406 can extend substantially perpendicular from the outer surface 404. In some embodiments, each of the plurality of helical vanes 406 can have an outer edge 414, an upper side 416 extending between the inner edge 408 and the outer edge 414, and a lower side 418 extending between the inner edge 408 and the outer edge 414. In some embodiments, the ratio of the length of at least one of the upper side 416 and the lower side 418 to the length of the outer edge 414 is from about 0.3 to about 0.9 or from about 0.4 to about 0.8 or from about 0.5 to about 0.7. In some embodiments, the rheometer attachment 40 can comprise up to six or up to five or up to four or up to three or up to two helical vanes 406. In some embodiments, at least a portion of each of the plurality of helical vanes 406 is at a variable helix angle 410, as measured from an axis 412 parallel to the shaft axis 402, which increases at a rate of at least about 1°/mm or at least about 2°/mm or at least about 3°/mm over the length of the inner edge 408 from upper side 416 to lower side 418. In some embodiments, the inner edge 408 is greater than about 65% or greater than about 75% or greater than about 80% of the length of the shaft 400.

In some embodiments, the plurality of helical vanes 306 and 406 shown in FIGS. 3 and 4, respectively, can be positioned anywhere along shaft 300 or 400 in addition to the positions shown in FIGS. 3 and 4.

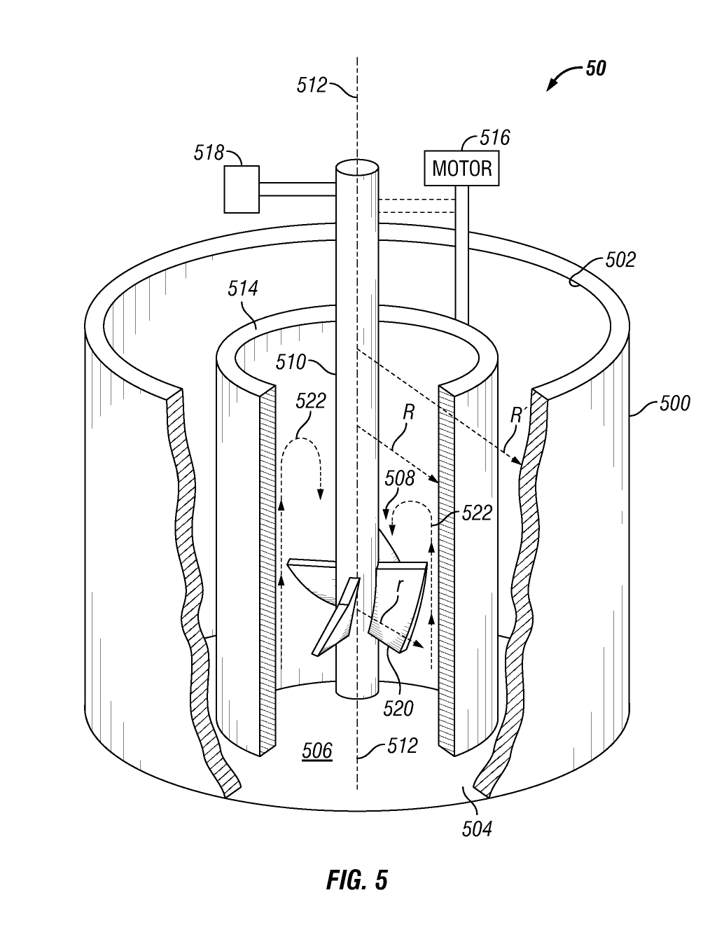

With reference to FIG. 5, in some embodiments, a rheometer 50 can comprise, consist of, or consist essentially of:
a container 500 having an inner surface 502 and a base 504 defining a cavity 506; and
a rheometer attachment 508 having a shaft 510 and a shaft axis 512, wherein the rheometer attachment 508 is disposed within the cavity 506.

In some embodiments, the rheometer 50 can also comprise a rotor 514 disposed within the cavity 506, a motor 516 connected to the rotor 514 for causing the rotor 514 to rotate relative to the rheometer attachment 508, and a torque measuring device 518 attached to the shaft 510.

Rheometer attachment 508 can be any rheometer attachment described herein, although it is shown in FIG. 5 as rheometer attachment 10 from FIG. 1.

In some embodiments, the difference between the radius r from the shaft axis 512 of the shaft 510 to an outer edge 520 of rheometer attachment 508 to an inner radius R of the rotor 514 can be from about 0.02 to about 1.5 cm or from about 0.03 to about 0.97 cm or from about 0.1 to about 0.6 cm.

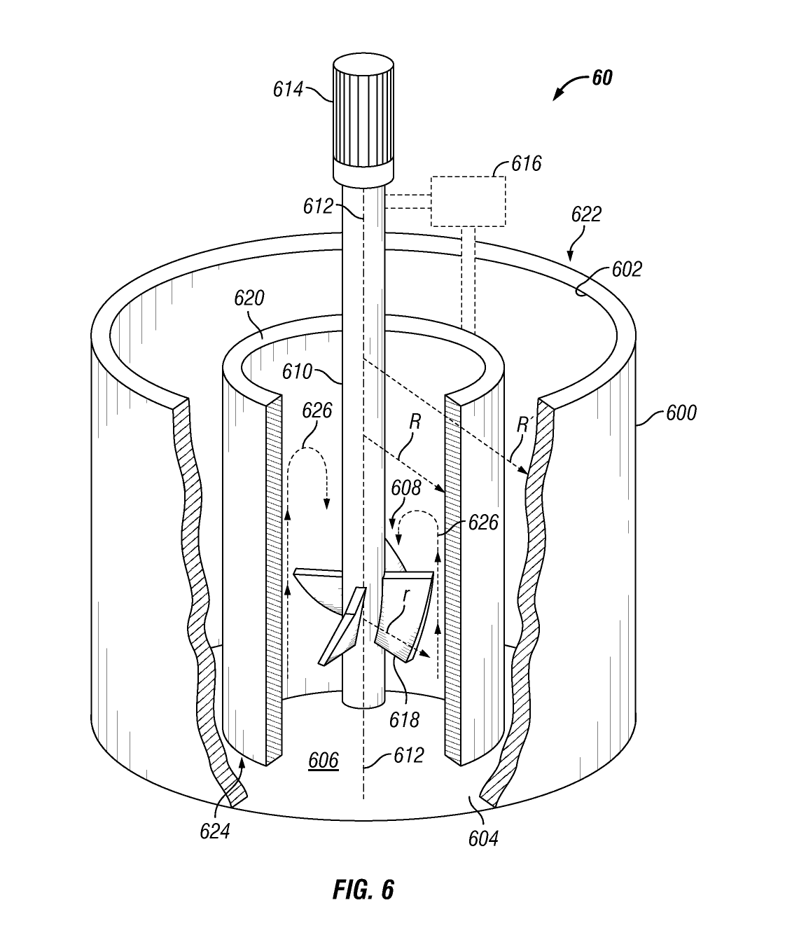

With reference to FIG. 6, in some embodiments, a rheometer 60 can comprise, consist of, or consist essentially of:
a container 600 having an inner surface 602 and a base 604 defining a cavity 606; and
a rheometer attachment 608 having a shaft 610 and a shaft axis 612, wherein the rheometer attachment 608 is disposed within the cavity 606.

In some embodiments, the rheometer 60 can also comprise a motor 614 connected to the shaft 610 of the rheometer attachment 608 for causing the rheometer attachment 608 to rotate relative to the container 600; and a torque measuring device 616 attached to the shaft 610 for measuring torque from the rheometer attachment 608.

In some embodiments, the difference between the radius r from the shaft axis 612 to the outer edge 618 of rheometer attachment 608 to the radius R′ of the container 600 can be from about 0.02 to about 1.5 cm or from about 0.03 to about 0.97 cm or from about 0.1 to about 0.6 cm.

In some embodiments, the rheometer 60 can also comprise a stator 620 disposed within the cavity 606, wherein the rheometer attachment 608 is disposed within the stator 620, and wherein the motor 614 causes the rheometer attachment 608 to rotate relative to the stator 620. In some embodiments, the torque measuring device 616 can be attached to either the stator 620 for measuring the torque from the stator 620 or to the shaft 610 for measuring torque from the rheometer attachment 608. In some embodiments, when the torque measuring device 616 is attached to the shaft 610, the stator 620 can be attached to the container 600 at the top 622 of container 600 or attached to the container 600 at the bottom 624 of container 600.

In some embodiments, and with reference to FIGS. 5 and/or 6, a method for measuring rheology can comprise, consist of or consist essentially of:
utilizing a rheometer as described herein for rheometers 50 or 60 comprising:
   a container (500 or 600) having an inner surface (502 or 602) and a base (504 or 604) defining a cavity (506 or 606);
   a cylindrical member selected from either a rotor 514 or a stator 620 disposed within the cavity;
   a rheometer attachment (508 or 608, as shown in FIGS. 1-4) comprising a shaft (510 or 610) having a shaft axis (512 or 612) and an outer surface and a plurality of helical vanes each extending radially from the outer surface, wherein the rheometer attachment is disposed within the cylindrical member;
   a motor (516 or 614) connected to either the cylindrical member or the shaft for causing the cylindrical member and the rheometer attachment to rotate relative to each other;
   a torque measuring device (518 or 616) attached to either the cylindrical member or the shaft for measuring torque;
introducing a fluid to the cavity; and
operating the motor to cause either the cylindrical member or the shaft to rotate; and
measuring the torque using the torque measuring device and determining a rheology indicator of the fluid as a function of the torque.

In some embodiments, the propeller movement of the plurality of helical vanes described herein (shown as reference numbers 106 in FIG. 1, 206 in FIG. 2, 306 in FIGS. 3 and 406 in FIG. 4) caused by the rotation of the rheometer attachment (508 or 608) relative to either: the container (500 or 600), the rotor 514 or the stator 620, moves the fluid away from its static location within the cavity (506 or 606). Such rotation is shown in FIG. 5 in the space between the rheometer attachment 508 and the rotor 514 (shown with indicator arrows 522); and shown in FIG. 6 as the space between the rheometer attachment 608 and the stator 620 (shown with indicator arrows 626), but can also be in the space between the rheometer attachment (508 or 608) and the container (500 or 600).

In some embodiments, the fluid comprises particles which can have a diameter from about 5 μm to about 5 mm or from about 50 μm to about 4 mm or from about 500 μm to about 3 mm. In some embodiments, the fluid can comprise at least about 5 or at least about 7 or at least about 10 percent solids.

In some embodiments, the fluid can comprise particles having a multimodal particle size distribution. In some embodiments, the fluid can be shear thinning or shear thickening. In some embodiments, the fluid can comprise fibers. The fibers can be of a size from about 2 to about 20 mm or from about 3 to about 12 mm or from about 4 to about 10 mm.

### Examples

A 300 mL quantity of a Fluid A was prepared and the formulation is given in Table 1 below.

TABLE 1

| | | Average particle | Largest particle |
|---|---|---|---|
| Fluid A | 300 mL | size (μm) | size (μm) |
| Liquid Additive | | | |
| Water | 141.16 g | | |
| Gelling Agent | 4.91 g | | |
| Surfacant: 4.23 g | | | |
| Rheology | | | |
| Modifier: 0.68 g | | | |
| Solid Blend Additives | | | |
| Particle 1 | 308.90 g | 350 | 420 |
| Particle 2 | 52.37 g | 150 | 150 |
| Particle 3 | 47.87 g | 30 | 60 |

Fluid A was a fluid having a multimodal particle size distribution. The Surfactant and Rheology Modifier formed a viscoelastic surfactant aqueous gel to improve particle suspension. Fluid A also had a solid concentration of 23 pounds proppant per gallon added (ppa), a solid volume fraction (SVF) of 51% and a density of 1.85 g/mL.

Fluid A was a shear thinning slurry, where viscosity decreases with increasing shear rate. The continuous phase fluid (Gelling Agent—the viscoelastic surfactant aqueous gel) undergoes shear alignment, where the shear induces semi-parallel configuration of the worm-like micelles. The full solid laden slurry also undergoes shear segregation, where the solid particle concentration changes with respect to shear rate and distance from the shear exerting device such as the rotary cylinder in a Fann 35 viscometer. For these reasons, it was difficult to measure the viscosity of the fluid, especially over time since the shear alignment and shear segregation were exacerbated. Shear segregation worsens as particles of bigger size are added.

### Rheological Testing

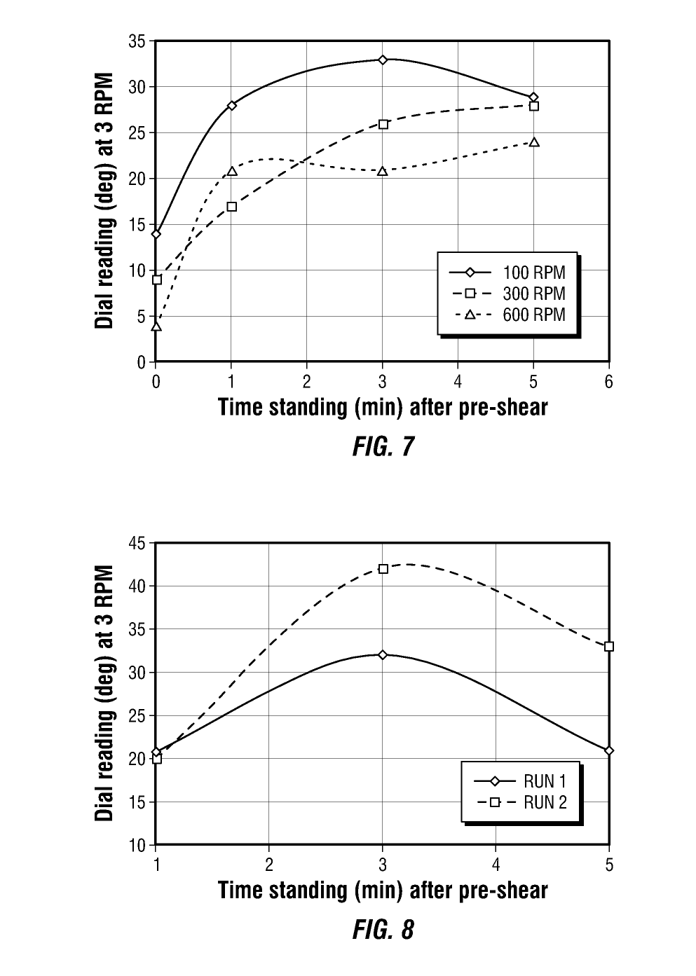

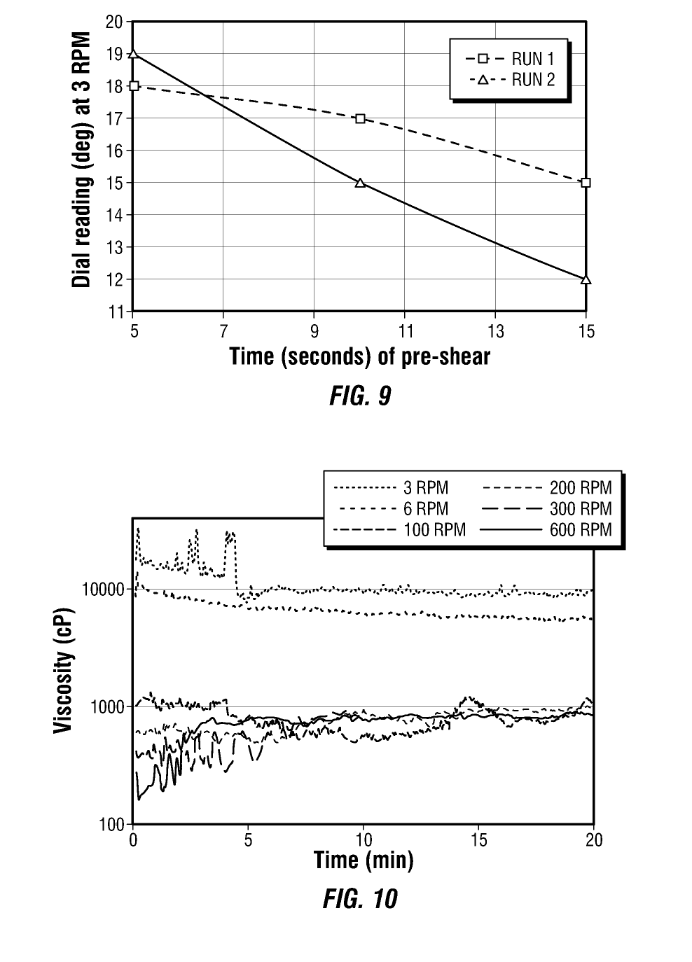

Different methods were used to obtain rheological data for Fluid A. First, a Fann 35 rheometer was used with rotor 1 (radius of rotor 1.8415 cm), bob 5 (radius of 1.15987 cm) and spring factor 1 (torsion spring constant of 386 dyne-cm/degree), and at 3 rpm to determine rheometer dial readings. The dial readings are shown at 3 rpm since rheology at low shear rates is indicative of yield stress and also shear slippage and segregation are diminished at lower shear rates. For each measurement, Fluid A was pre-sheared and then left to relax to erase any pre-existing conditions from loading the viscometer, as well as to fill the annulus gap between the sleeve and the bob with Fluid A. FIG. 7 indicates the dial readings of Fluid A, where the fluid was pre-sheared for 3 seconds at 100, 300, and 600 rpm, then was left standing for varying times before ramp-up. It was apparent in the 600 rpm data that the shear was too high and led to observable fluid segregation, where the solid and liquid components of Fluid A separated in the annulus due to heavy shearing. FIG. 8 shows dial reading data of Fluid A at 3 rpm, where the fluid was pre-sheared at 300 rpm for 3 seconds and then let stand for varying times before ramp-up. Run 1 and Run 2 were duplicates of each other, where two samples from the same fluid batch were measured under the same conditions. As can be seen from FIG. 8, the reading for Run 1 was not reproducible in Run 2. FIG. 9 indicates the dial readings of Fluid A at 3 rpm, where the fluid was pre-sheared at 300 rpm for varying times and was let to stand for 1 min at no shear. Run 1 and Run 2 were duplicates of each other, and the results indicate little to no reproducibility of data at different pre-shear times. After pre-shearing, the viscosity recovers and it is expected for the dial readings to stay constant, however, this was not observed at any specific pre-shear rate or pre-shear time as shown in FIG. 9.

Further testing of Fluid A was performed with a Grace M3600 viscometer to monitor the deviation in viscosity readings when utilizing a bob 5, and rotor 1. In this test, the fluid was tested over time at a constant shear rate in order to see if consistent viscosity readings could be achieved at any point in time. Results of the testing, plotting viscosity (cP) over time, are shown in FIG. 10. As can be seen in FIG. 10, a large degree of variability is observed likely due to slippage.

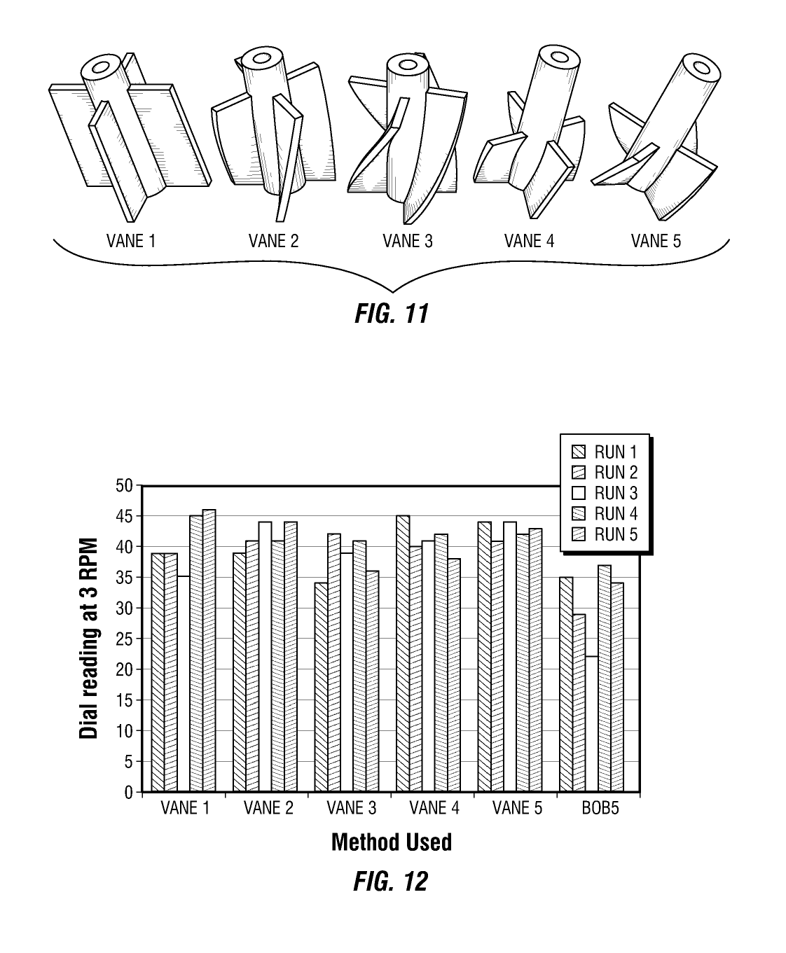

Other bob designs were used to determine whether measurement reproducibility could be improved. In order to minimize fluid shear slippage and shear segregation, five helical vane geometry bobs (Vanes 1-5) were designed and produced. FIG. 11 shows the designs for Vanes 1-5, and Table 2 includes the vane lengths and helix angles for Vanes 1-5. These new geometries were used to test Fluid A at 3 rpm using a Fann 35 rheometer, rotor 1 and spring factor 1, by replacing the conventional BOB5.

TABLE 2

| | Vane Geometry | Vane Angle | Vane Length |
|---|---|---|---|
| Vane 1 | Straight, tall | 0° | 38 mm |
| Vane 2 | Twisted, tall | 15.3° | 38 mm |
| Vane 3 | Twisted, tall | 33° | 38 mm |
| Vane 4 | Twisted, short | 15.3° | 19 mm |
| Vane 5 | Twisted, short | 33° | 19 mm |

The results from the dial readings at 3 rpm for each geometry (Vanes 1-5 and BOB5) tested for Fluid A are presented in FIG. 12. For each of the Vanes 1-5 and the BOB5, five identical Runs were performed to determine reproducibility of the dial readings. Each of the Runs were performed without pre-shear. As can be seen from FIG. 12 and Table 3 below, Vane 5 produced better overall observable results in terms of less shear segregation and slippage and reproducibility than the other Vanes or BOB5. Also, each of the helical Vanes 2-5 showed superior reproducibility as compared to the standard BOB5.

TABLE 3

| | STDEV | AVG | % STDEV |
|---|---|---|---|
| Vane 1 | 4.60 | 40.8 | 11% |
| Vane 2 | 2.17 | 41.8 | 5% |
| Vane 3 | 3.36 | 38.4 | 9% |
| Vane 4 | 2.59 | 41.2 | 6% |
| Vane 5 | 1.30 | 42.8 | 3% |
| BOB5 | 6.02 | 31.4 | 19% |

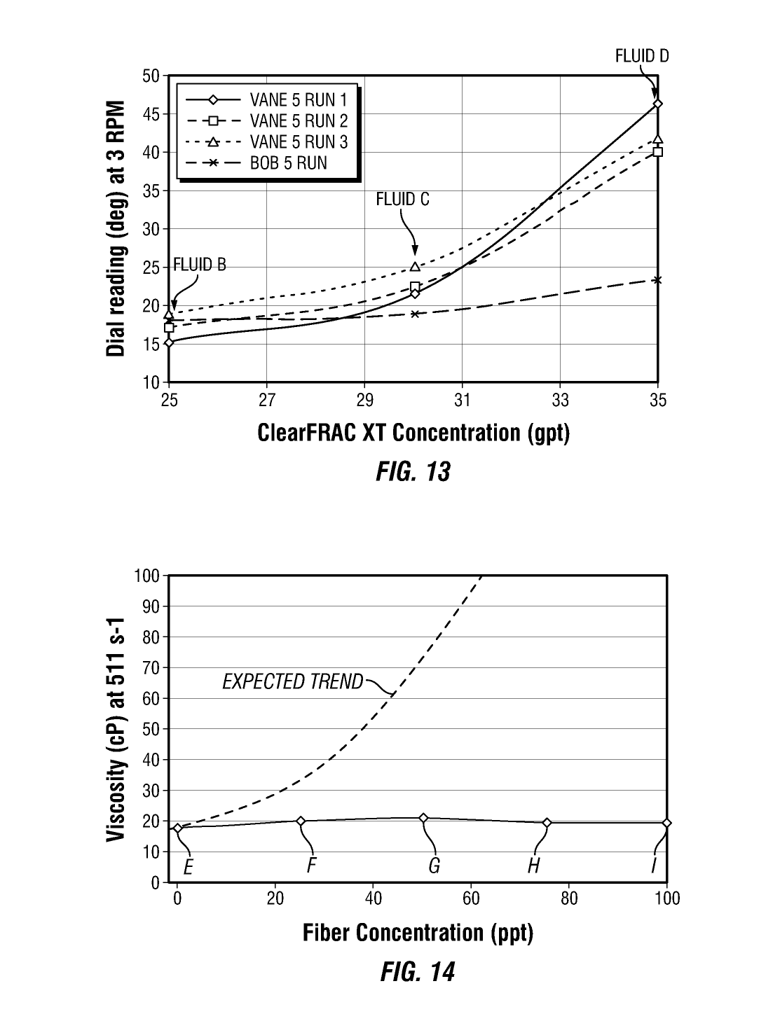

Fluids B, C and D were prepared and contained water and Gelling Agent (Surfactant and Rheology Modifier). Fluid B contained 25 gallons/thousand gallons (gpt) of Gelling Agent, Fluid C contained 30 gpt of Gelling Agent and Fluid D contained 35 gpt of Gelling Agent. Fluids B-D were tested at 3 rpm using a Fann 35, rotor 1 and spring constant 1, using Vane 5 without pre-shear in duplicate Runs 1-3. Fluids B-D were also tested in the same Fann 35 using BOB5, pre-shearing at 300 rpm for 5-6 seconds, and letting stand for 1 minute. The resulting dial readings are shown in FIG. 13 and show that measurement using the Vane 5 attachment is superior to the BOB5 attachment by showing a significant increase in dial reading with increasing Gelling Agent concentration as compared to the results for BOB5 which was only slightly increased. This data demonstrates that helical vanes such as Vane 5 can be used as tools for the QAQC in the field for complex viscoelastic fluids.

Fluids E-I were prepared and contained water, guar and varying amounts of fiber. Fluid E contained no added fiber, Fluid F contained 25 pounds per thousand gallons of water (ppt) of fiber, Fluid G contained 50 ppt of fiber, Fluid H contained 75 ppt of fiber, and Fluid I contained 100 ppt of fiber. The viscosity for fluids E-I were each measured in the Fann 35 rheometer using the BOB1, rotor 1, spring factor 1. FIG. 14 shows the results, and as can be seen, the viscosities of linear guar fluids with fiber concentrations ranging from 0 to 100 ppt measured with this typical concentric rotation viscometer (Fann 35) failed to reveal any differences.

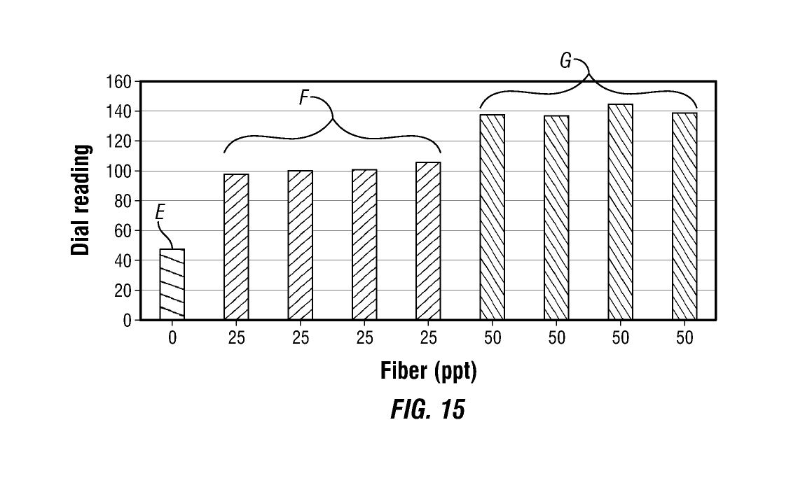

Fluids E, F and G were tested in the same Fann 35 rheometer using the Vane 5. Four duplicate measurements were made for each of the F and G fluids. As shown in FIG. 15, the measurement of the three Fluids E, F and G with different fiber concentration clearly showed differences. In fact, the repeatability is also shown to be good.

The foregoing description of the embodiments has been provided for purposes of illustration and description. Example embodiments are provided so that this disclosure will be thorough, and will fully convey the scope to those who are skilled in the art. Numerous specific details are set forth such as examples of specific components, devices, and methods, to provide a thorough understanding of embodiments of the disclosure, but are not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may be present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,”, “center”, “beneath,” “below,” “lower,” “above,” “upper,” “top,” “bottom” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although various embodiments have been described with respect to enabling disclosures, it is to be understood the invention is not limited to the disclosed embodiments. Variations and modifications that would occur to one of skill in the art upon reading the specification are also within the scope of the invention, which is defined in the appended claims.

What is claimed is:

1. A rheometer attachment comprising a shaft having a shaft axis and an outer surface and a plurality of helical vanes each extending radially from the outer surface.

2. The rheometer attachment of claim 1 wherein the plurality of helical vanes each have an inner edge attached to the outer surface of the shaft.

3. The rheometer attachment of claim 2 wherein at least a portion of each of the plurality of helical vanes is at a variable helix angle, as measured from an axis parallel to the shaft axis, which increases at a rate of at least 1°/mm over the length of the inner edge from top to bottom.

4. The rheometer attachment of claim 2 wherein at least a portion of each of the plurality of helical vanes is at a fixed helix angle, as measured from an axis parallel to the shaft axis, of from about 5 to about 60 degrees.

5. The rheometer attachment of claim 1 wherein the plurality of helical vanes extend substantially perpendicular from the outer surface.

6. The rheometer attachment of claim 1 wherein each of the plurality of helical vanes has an outer edge, an upper side extending between the inner edge and the outer edge, and a lower side extending between the inner edge and the outer edge.

7. The rheometer attachment of claim 6 wherein the ratio of the length of at least one of the upper side and the lower side to the length of the outer edge is from about 0.3 to about 0.9.

8. The rheometer attachment of claim 1 comprising up to six helical vanes.

9. A rheometer comprising:
a container having an inner surface and a base defining a cavity; and
a rheometer attachment comprising a shaft having a shaft axis and an outer surface and a plurality of helical vanes each extending radially from the outer surface, wherein the rheometer attachment is disposed within the cavity.

10. The rheometer of claim 9 wherein at least a portion of each of the plurality of helical vanes is at a fixed helix angle, as measured from an axis parallel to the shaft axis, of from about 5 to about 60 degrees.

11. The rheometer of claim 9 wherein each of the plurality of helical vanes has an inner edge attached to the outer surface of the shaft, an outer edge, an upper side extending between the inner edge and the outer edge, and a lower side extending between the inner edge and the outer edge.

12. The rheometer of claim 11 wherein the ratio of the length of at least one of the upper side and the lower side to the length of the outer edge is from about 0.3 to about 0.9.

13. The rheometer of claim 11 further comprising:
a rotor disposed within the cavity, wherein the rheometer attachment is disposed within the rotor;
a motor connected to the rotor for causing the rotor to rotate relative to the rheometer attachment; and
a torque measuring device attached to the shaft for measuring torque from the rheometer attachment.

14. The rheometer of claim 13 wherein the difference between the radius from the shaft axis to the outer edge to the radius of the rotor is from about 0.02 to about 1.5 cm.

15. The rheometer of claim 11 further comprising:
a motor connected to the rheometer attachment for causing the rheometer attachment to rotate relative to the container; and
a torque measuring device attached to the shaft for measuring torque from the rheometer attachment.

16. The rheometer of claim 15 wherein the difference between the radius from the shaft axis to the outer edge to the radius of the container is from about 0.02 to about 1.5 cm.

17. The rheometer of claim 15 further comprising:
a stator disposed within the cavity, wherein the rheometer attachment is disposed within the stator, and wherein the motor causes the rheometer attachment to rotate relative to the stator; and
a torque measuring device attached to the stator for measuring torque from the stator.

18. A method for measuring rheology comprising:
utilizing a rheometer comprising:
a container having an inner surface and a base defining a cavity;
a cylindrical member selected from either a rotor or a stator disposed within the cavity;
a rheometer attachment comprising a shaft having a shaft axis and an outer surface and a plurality of helical vanes each extending radially from the outer surface, wherein the rheometer attachment is disposed within the cylindrical member;
a motor connected to either the cylindrical member or the shaft for causing the cylindrical member and the rheometer attachment to rotate relative to each other;
a torque measuring device attached to either the cylindrical member or the shaft for measuring torque;
introducing a fluid to the cavity; and
operating the motor to cause either the cylindrical member or the shaft to rotate; and
measuring the torque using the torque measuring device and determining a rheology indicator of the fluid as a function of the torque.

19. The method of claim 18 wherein the propeller movement of the plurality of helical vanes caused by the rotation of the cylindrical member relative to the rheometer attachment moves the fluid away from its static location within the cavity.

20. The method of claim 18 wherein at least a portion of each of the plurality of helical vanes is at a fixed helix angle, as measured from an axis parallel to the shaft axis, of from about 5 to about 60 degrees.
